(19) United States
(12) Patent Application Publication
(10) Pub. No.: US 2006/0016515 A1
(43) Pub. Date: Jan. 26, 2006

(54) Sinter magnet made from rare earth-iron-boron alloy powder for magnet

(76) Inventors: Hiroyuki Tomizawa, Osaka (JP); Yuji Kaneko, Kyoto (JP); Tomoori Odaka, Osaka (JP)

Correspondence Address: NIXON PEABODY, LLP, 401 9TH STREET, NW, SUITE 900, WASHINGTON, DC, 20004-2128, US

(21) Appl. No.: 10/503,359

(22) PCT Filed: Feb. 4, 2003
(86) PCT No.: PCT/JP03/01143

§ 371 Date: Aug. 3, 2004

(30) Foreign Application Priority Data
Feb. 5, 2002 (JP) 2002-28207

(51) Int. Cl. H01F 1/057

(52) U.S. Cl. 148/101; 148/302

(57) ABSTRACT

A rare-earth-iron-boron based alloy powder, in which a heavy rare-earth element such as Dy is present at a higher concentration in a main phase than in a grain boundary phase and which can be sintered easily, and a method of making such an alloy powder are provided. A rare-earth-iron-boron based magnet alloy according to the present invention includes, as a main phase, a plurality of R₂Fe₁₄B type crystals (where R is at least one element selected from the group consisting of the rare-earth elements and yttrium) in which rare-earth-rich phases are dispersed. The main phase includes Dy and/or Tb at a higher concentration than a grain boundary phase does.

### TECHNICAL FIELD

The present invention relates to a rare-earth-iron-boron based alloy, a sintered magnet, and methods of making them.

### BACKGROUND ART

A rare-earth-iron-boron based rare-earth magnet (which will be sometimes referred to herein as an “R—Fe—B based magnet”) is a typical high-performance permanent magnet, has a structure including, as a main phase, an R₂Fe₁₄B-type crystalline phase, which is a ternary tetragonal compound, and exhibits excellent magnet performance. In R₂Fe₁₄B, R is at least one element selected from the group consisting of the rare-earth elements and yttrium and portions of Fe and B may be replaced with other elements.

Such R—Fe—B based magnets are roughly classifiable into sintered magnets and bonded magnets. A sintered magnet is produced by compacting a fine powder of an R—Fe—B based magnet alloy (with a mean particle size of several μm) with a press machine and then sintering the resultant compact. On the other hand, a bonded magnet is usually produced by compacting a compound of a powder of an R—Fe—B based magnet alloy (with particle sizes of about 100 μm) and a binder resin within a press machine.

A powder for use to produce such an R—Fe—B based magnet is made by pulverizing an R—Fe—B based magnet alloy. In the prior art, such an R—Fe—B based magnet alloy has been made either by an ingot process using a die casting technique or by a strip casting process for rapidly cooling a molten alloy with a chill roller.

In the alloy prepared by the ingot process, Fe primary crystals, crystallized while the melt is being gradually cooled, remains as α-Fe in the structure, thus decreasing the pulverization efficiency or the coercivity of the resultant magnet significantly. To overcome this problem, a solution treatment must be carried out to remove Fe from the alloy obtained by the ingot process. The solution treatment is a heat treatment to be conducted at an elevated temperature exceeding 1,000° C. for a long time, which should make the productivity decline and should raise the manufacturing cost. In addition, in the process step of sintering an alloy powder in the ingot process, local low-melting phases to be liquid phases are present here and there. Accordingly, unless the sintering temperature is set high and unless the sintering time is set long, a sufficient sintered density cannot be achieved. As a result, main-phase crystal grains grow excessively during the sintering process, thus making it difficult to obtain a sintered magnet with high coercivity.

In contrast, in the alloy prepared by the strip casting process, the molten alloy is rapidly cooled and solidified by a chill roller, for example. Thus, the resultant structure can have a desired small grain size. As a result, a rapidly solidified alloy, in which low-melting grain boundary phases to be liquid phases during the sintering process are distributed uniformly and finely, can be obtained. If those grain boundary phases are distributed uniformly and finely in the alloy, then main and grain boundary phases are highly likely to be in contact with each other in the powder particles obtained by pulverizing the alloy. Thus, the grain boundary phases turn into liquid phases smoothly in the sintering process, thereby advancing the sintering process quickly. Consequently, the sintering temperature can be lowered, the sintering time can be shortened, and a sintered magnet exhibiting high coercivity can be obtained with the excessive growth of crystal grains minimized. In addition, in the strip casting process, almost no α-Fe is crystallized in the rapidly solidified alloy, and therefore, there is no longer any need to carry out the solution treatment.

In the strip-cast alloy, however, the structure is so fine that it is difficult to finely pulverize the respective powder particles to single crystalline grains. If the powder particles are polycrystalline, then the degree of magnetic anisotropy is low. In that case, even if the powder particles are aligned, compressed and compacted under a magnetic field, a desired sintered magnet, in which the main phase has been aligned to such a degree as to achieve a high remanence, cannot be produced.

Meanwhile, to increase the heat resistance of R—Fe—B based sintered magnets and keep their coercivity high enough even at a high temperature, Dy has often been added to the material alloy. Dy is a rare-earth element, which has the effect of increasing the magnetic anisotropy of an R₂Fe₁₄B phase that is the main phase of an R—Fe—B based sintered magnet. However, Dy is an element of which the supply is very limited. Accordingly, if electric cars are popularized so much in the near future as to generate higher and higher demand for refractory magnets for use in a motor for an electric car, for example, then the resources of Dy will be on the verge of being exhausted soon and there will be a deep concern about a steep rise in material cost. In view of this potential situation, techniques for reducing the amount of Dy to be added to a high-coercivity magnet must be developed as soon as possible to cope with such a demand. Nevertheless, in a strip-cast alloy, even if heavy rare-earth elements such as Dy are added thereto to increase the coercivity, for example, those heavy rare-earth elements will also be distributed in the grain boundary phases and the concentration of the heavy rare-earth elements in the main phase will decrease, which is also a problem. A heavy rare-earth element such as Dy cannot contribute to improving the magnet performance unless that element is included in the main phase. If the rapid cooling rate of the molten alloy is sufficiently low, Dy tends to be absorbed into, and settled in, the main phase. However, if the cooling rate is relatively high as in the strip casting process, then Dy will not be allowed enough time to diffuse from the grain boundary portions into the main phase while the molten alloy is being solidified. To avoid these problems, a method of condensing Dy in the main phase by lowering the cooling rate of the molten alloy may be adopted. But if the molten alloy were cooled at a decreased rate, then the crystal grains would increase their sizes too much and α-Fe should be produced as already described for the ingot alloy.

In order to overcome the problems described above, an object of the present invention is to provide a rare-earth-iron-boron based alloy powder, in which a heavy rare-earth element such as Dy is present at a higher concentration in the main phase than in the grain boundary phases and which can be sintered easily, and a method of making such an alloy powder.

Another object of the present invention is to provide a material alloy for the powder, a sintered magnet made from the powder, and methods of making them.

### DISCLOSURE OF INVENTION

A rare-earth-iron-boron based magnet alloy according to the present invention includes, as a main phase, a plurality of R₂Fe₁₄B type crystals (where R is at least one element selected from the group consisting of the rare-earth elements and yttrium) in which rare-earth-rich phases are dispersed. The main phase includes Dy and/or Tb at a higher concentration than a grain boundary phase does.

In one preferred embodiment, the alloy includes 2.5 mass % to 15 mass % of Dy and/or Tb.

In another preferred embodiment, the ratio of Dy and/or Tb to the main phase is at least 1.03 times as high as the ratio of Dy and/or Tb to the overall alloy.

In another preferred embodiment, the alloy includes at most 5 vol % of α-Fe phase.

In another preferred embodiment, the alloy includes 27 mass % to 35 mass % of the rare-earth element.

A rare-earth-iron-boron based magnet alloy powder according to the present invention is obtained by pulverizing any of the alloys described above.

A sintered magnet according to the present invention is made from the rare-earth-iron-boron based magnet alloy powder described above.

A method of making a rare-earth-iron-boron based magnet alloy according to the present invention includes the steps of: preparing a melt of a rare-earth-iron-boron based alloy; and making a solidified alloy by quenching the melt. The step of making the solidified alloy includes the step of forming a solidified alloy layer, including, as a main phase, a plurality of R₂Fe₁₄B-type crystals (where R is at least one element selected from the group consisting of the rare-earth elements and yttrium) in which rare-earth-rich phases are dispersed, by quenching the melt through contact with a cooling member. The main phase includes Dy and/or Tb at a higher concentration than a grain boundary phase does.

In one preferred embodiment, the alloy includes 2.5 mass % to 15 mass % of Dy and/or Tb.

In another preferred embodiment, the ratio of Dy and/or Tb to the main phase is at least 1.03 times as high as the ratio of Dy and/or Tb to the overall alloy.

In another preferred embodiment, the step of forming the solidified alloy layer includes forming a first texture layer in contact with the cooling member and then further feeding the melt onto the first texture layer to grow the R₂Fe₁₄B-type crystals on the first texture layer, thereby forming a second texture layer thereon.

In another preferred embodiment, in forming the first texture layer, the melt is quenched at a rate of 10° C./s to 1,000° C./s and at a supercooling temperature of 100° C. to 300° C. In forming the second texture layer, the melt is quenched at a rate of 1° C./s to 500° C./s. The cooling rate of the molten alloy while the second texture layer is being formed is lower than that of the molten alloy while the first texture layer is being formed.

In another preferred embodiment, the R₂Fe₁₄B-type crystals have an average minor-axis size of at least 20 μm and an average major-axis size of at least 100 μm.

In another preferred embodiment, the rare-earth-rich phases are dispersed at an average interval of 10 μm or less in the R₂Fe₁₄B-type crystals.

The solidified alloy includes at most 5 vol % of α-Fe phase.

The rare-earth element included in the solidified alloy has a concentration of 27 mass % to 35 mass %.

In a preferred embodiment, the solidified alloy layer is formed by a centrifugal casting process.

A method of making a magnet powder for a sintered magnet according to the present invention includes the steps of: preparing the rare-earth-iron-boron based magnet alloy by any of the methods described above; and pulverizing the alloy.

A method for producing a sintered magnet according to the present invention includes the steps of: preparing the rare-earth-iron-boron based magnet alloy powder described above; compressing the powder under an aligning magnetic field to make a compact; and sintering the compact.

### BRIEF DESCRIPTION OF DRAWINGS

FIGS. 1(a) through 1(d) are cross-sectional views schematically illustrating how a rare-earth-iron-boron based magnet alloy for use to make a magnet powder according to the present invention forms its structure.

FIGS. 2(a) through 2(c) are cross-sectional views schematically illustrating how the structure of a rare-earth-iron-boron based magnet alloy is formed by a strip casting process.

FIGS. 3(a) through 3(d) are cross-sectional views schematically illustrating how the structure of a rare-earth-iron-boron based magnet alloy is formed by a conventional ingot process.

FIG. 4 is a graph showing the magnetization characteristics of sintered magnets representing a specific example of the present invention and a comparative example, in which the abscissa represents the strength of a magnetizing field applied to the sintered magnet and the ordinate represents the magnetizing percentage.

FIG. 5 is a polarizing micrograph of a rare-earth-iron-boron based magnet alloy according to the present invention showing a texture cross section near its surface contacting with a cooling member.

FIG. 6 is a polarizing micrograph of a rare-earth-iron-boron based magnet alloy according to the present invention showing a texture cross section of a center portion in the thickness direction.

### BEST MODE FOR CARRYING OUT THE INVENTION

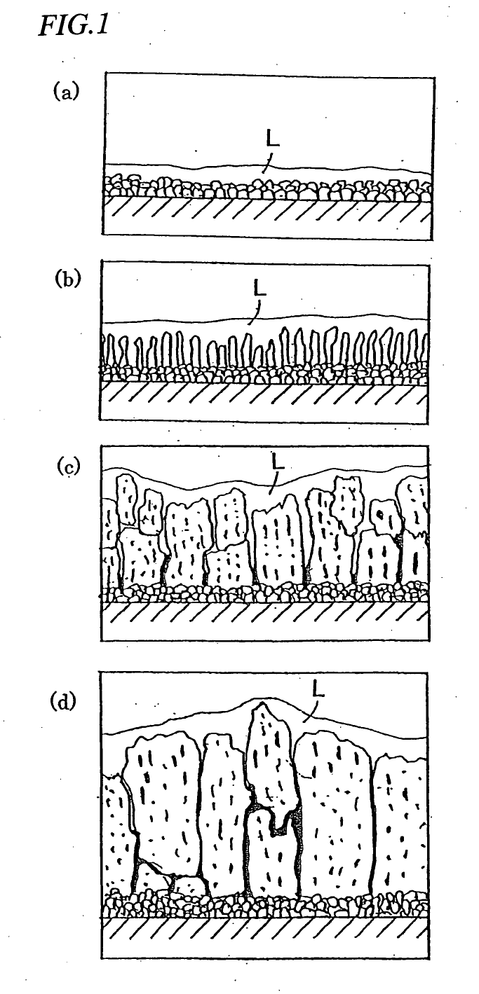

The present inventors estimated concentration distributions of Dy in rare-earth-iron-boron based magnet alloys with various textures and structures. As a result, we discovered that Dy was present at a higher concentration in the main phase (i.e., R₂Fe₁₄B type crystals) than in the grain boundary phase in the rare-earth-iron-boron based magnet alloy having a structure such as that shown in FIG. 1(d).

FIG. 1(d) schematically illustrates the structure of a rare-earth-iron-boron based magnet alloy according to the present invention. This alloy has a structure in which very small rare-earth-rich phases (shown as black dotted regions in FIG. 1(d)) are dispersed in relatively coarse columnar crystals. Such an alloy including a plurality of columnar crystals, in which the rare-earth-rich phases are dispersed, can be formed by cooling and solidifying a melt of a rare-earth-iron-boron based alloy through contact with a cooling member. The composition of the alloy is characterized by R in an excessive mass, representing R-rich ingredients, as compared with the stoichiometry of R₂Fe₁₄B type crystals. If necessary, any of various elements may be added to the alloy used. For example, if the composition of the rare-earth-iron-boron based magnet alloy is represented by R1ₓ₁R2ₓ₂T_{100-x1-x2-y-z}Q_{y}M_{z} (in mass percentages) where R1 is at least one element selected from the group consisting of the rare-earth elements (except R2) and yttrium, T is Fe and/or Co, Q is at least one element selected from the group consisting of B (boron) and C (carbon), R2 is at least one element selected from the group consisting of Dy and Tb, M is at least one element selected from the group consisting of Al, Ti, V, Cr, Mn, Ni, Cu, Zn, Ga, Zr, Nb, Mo, In, Sn, Hf, Ta, W and Pb, and a portion of B may be replaced with N, Si, P and/or S, then 27≦x1+x2≦35, 0.95≦y≦1.05, 2.5≦x2≦15 and 0.1≦z≦2 (where x, y and z represent mass percentages) are preferably satisfied.

Hereinafter, a preferred method of making the alloy will be described in detail with reference to FIGS. 1(a) through 1(d).

First, as shown in FIG. 1(a), the molten alloy L is brought into contact with a cooling member (e.g., a copper chill plate or chill roller), thereby forming a thin first texture layer, including very small primary crystals (of R₂Fe₁₄B), on its side in contact with the cooling member. After the first texture layer has been formed or while the first texture layer is being formed, the molten alloy L is further fed onto the first texture layer, thereby growing columnar crystals (i.e., R₂Fe₁₄B type crystals) on the first texture layer (see FIG. 1(b)). These columnar crystals are formed by continuously feeding the molten alloy but cooling the molten alloy at a lower cooling rate than the initial one. As a result, as shown in FIG. 1(c), the solidification advances before the rare-earth element, included in the molten alloy supplied relatively slowly, diffuses and reaches the grain boundary of those underlying coarse columnar crystals, thus rapidly growing the columnar crystals in which the rare-earth-rich phases are dispersed. By setting the cooling rate relatively high while primary crystals are being formed during an early stage of the solidification process and by slowing down the cooling rate during the subsequent crystal growth, the second texture layer, including excessively large columnar crystals, can be obtained in the end as shown in FIG. 1(d).

The second texture layer is cooled on the high-temperature first texture layer that has just been solidified. Accordingly, just by controlling the melt feeding rate, the cooling rate of the second texture layer can be set lower than that of the first texture layer without using any special means.

In forming the first texture layer as an aggregation of very small primary crystals, the molten alloy is preferably cooled at a rate of 10° C. Is to 1,000° C. Is and at a supercooling temperature of 100° C. to 300° C. The supercooling can minimize the nucleation of the Fe primary crystals. On the other hand, in forming the second texture layer, the molten alloy is preferably cooled at a rate of 1° C./s to 500° C./s while being fed continuously.

The cooling rate is adjusted according to the rate of feeding the melt onto the cooling member. Thus, to obtain the structure described above, it is important to adopt a cooling method that allows for adjustment of the melt feeding rate. More specifically, to obtain the structure of the present invention, the melt is preferably constantly fed little by little onto a cooling member (such as a casting mold). For that reason, a cooling process of scattering or atomizing droplets of the melt is preferably carried out. For example, a method of atomizing a melt flow by blowing a gas jet against it or a method of scattering the droplets with centrifugal force may be adopted.

Another point in the melt quenching method of the present invention is to collect the produced melt droplets on the cooling member at a high yield (i.e., use the droplets efficiently enough to make a solidified alloy). To increase the yield, a method of blowing the melt droplets onto a flat-plate cooling member or a water-cooled mold with a gas spray or a method of scattering the melt droplets against the inner walls of a rotating cylindrical drum-like cooling member (i.e., a centrifugal casting process) is preferably adopted. Alternatively, a method of producing the melt droplets by a rotating electrode method and depositing them on the cooling member may also be adopted. In any case, the point is to create crystal nuclei in the areas to contact with the cooling member and to feed a molten alloy thereon relatively slowly. In this manner, the special structure described above can be formed with an adequate balance struck between the quantity of heat to be dissipated during the cooling process and the melt feeding rate.

According to the cooling process described above, large columnar crystals with an average minor-axis size of 20 μm or more and an average major-axis size of 100 μm or more can be grown. The rare-earth-rich phases, dispersed in the columnar crystals, preferably have an average interval of 10 μm or less.

No solidified alloy with such a texture and structure could be obtained by any conventional method such as a strip casting process or an alloy ingot process. Hereinafter, it will be described how crystals grow in a solidified alloy to be a rare-earth-iron-boron magnet alloy (which will be simply referred to herein as a “solidified alloy”) by a conventional process.

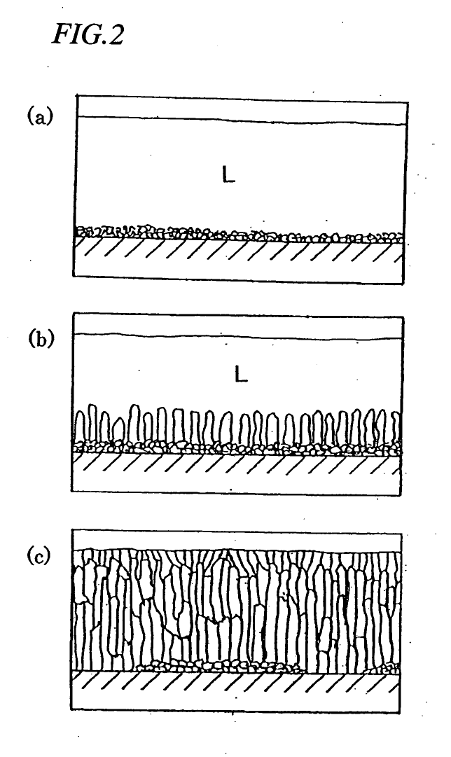

First, it will be described with reference to FIGS. 2(a) through 2(c) how crystals grow in a strip casting process. A strip casting process results in a relatively high cooling rate. Accordingly, a molten alloy L, having contacted with the outer surface of a cooling member such as a chill roller that is rotating at a high speed, is rapidly cooled and solidified from its contact surface. To achieve a high cooling rate, the amount of the molten alloy L needs to be decreased. Also, considering the mechanism of the strip caster, the molten alloy cannot be supplied sequentially. Accordingly, the thickness of the molten alloy L on the cooling member does not increase, but remains substantially constant, throughout the quenching process. In the molten alloy L with such a constant thickness, the crystal growth advances rapidly from the surface contacting with the cooling member. Since the cooling rate is high, the minor-axis sizes of the columnar crystals are small as shown in FIGS. 2(a) through 2(c), and the resultant solidified alloy has a fine structure. The rare-earth-rich phases are not present inside of the columnar texture but are dispersed on the grain boundary. In the strip-cast alloy, the crystal grains have such small sizes that regions with aligned crystal orientation are small. Accordingly, the magnetic anisotropy of the respective powder particles decrease.

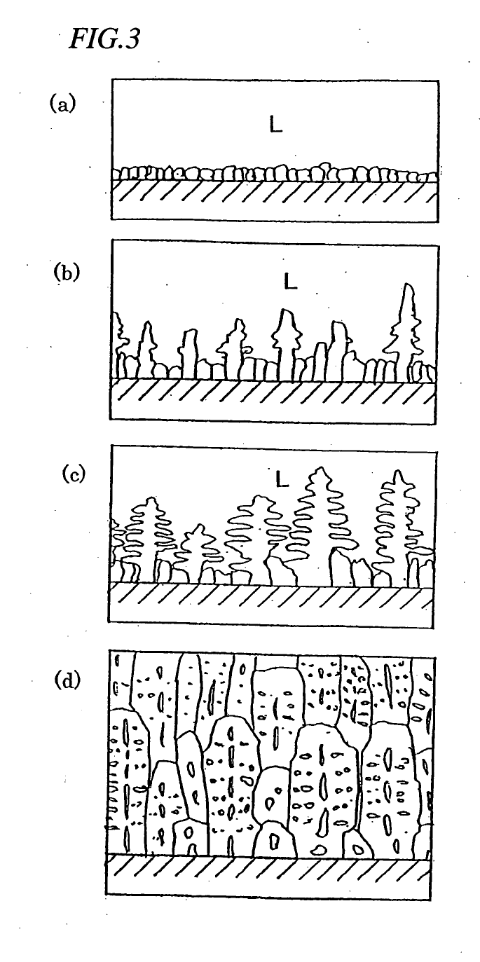

Next, it will be described with reference to FIGS. 3(a) through 3(d) how crystals grow in a conventional ingot process. An ingot process results in a relatively low cooling rate. Accordingly, a molten alloy L, having contacted with a cooling member, is slowly cooled and solidified from that contact surface. Inside of the still molten alloy L, first, Fe primary crystals are produced on the surface contacting with the cooling member and then dendritic crystals of Fe are going to grow as shown in FIGS. 3(b) and 3(c). An R₂Fe₁₄B type crystalline phase is finally formed by a peritectic reaction but still includes some α-Fe phases that would deteriorate the magnet performance. The solidified alloy has a coarse structure and includes more than 5 vol % of big α-Fe phases. To decrease the α-Fe, a homogenizing process needs to be carried out. Specifically, by diffusing and eliminating the α-Fe and R₂Fe₁₇ phases in the ingot alloy as much as possible, the resultant structure should be made to consist essentially of the R₂Fe₁₄B and R-rich phases only. The homogenizing heat treatment is carried out at a temperature of 1,100° C. to 1,200° C. for 1 to 48 hours within either an inert atmosphere (except a nitrogen atmosphere) or a vacuum. Such a homogenizing treatment adversely increases the manufacturing cost. Meanwhile, to minimize the production of the α-Fe, the mole fraction of the rare-earth element included in the material alloy needs to be sufficiently greater than that defined by stoichiometry. However, if the mole fraction of the rare-earth element is increased, then the remanence of the resultant magnet will decrease and the corrosion resistance thereof will deteriorate, which are problems.

On the other hand, the rare-earth-iron-boron based magnet alloy for use in the present invention (see FIG. 1) includes a rare-earth element at a mole fraction close to that defined by stoichiometry, but is less likely to produce α-Fe, which is advantageous. Accordingly, the rare-earth content can be reduced than that of the conventional process. Also, the alloy for use in the present invention has a metallographic structure including columnar crystals in which the rare-earth-rich phases are dispersed. For that reason, when the alloy is pulverized into powder particles, rare-earth-rich phases to turn into liquid phases easily are more likely to appear on the surface of the powder particles. As a result, sintering is achieved to a sufficient degree at a lower temperature and in a shorter time than the conventional process and the excessive grain growth during the sintering process can be minimized. In addition, the rare-earth-rich phases are finely dispersed in the columnar crystals, and therefore, the probability of losing the rare-earth-rich phases as superfine powder in the pulverizing process decreases, too.

Furthermore, in the alloy for use in the present invention, Dy and Tb added are likely to be concentrated in the main phase rather than on the grain boundary as described above. This is because the cooling rate of the molten alloy is lower than that achieved by the strip casting process and Dy and Tb are introduced into the main phase more easily. Thus, in a preferred embodiment of the present invention, even if the concentration of Dy or Tb, which is one of rare natural resources, is defined to fall within the range of 2.5 mass % to 15 mass %, the effects achieved by that addition are comparable to a situation where the concentration of Dy or Tb is set to 3.0 mass % to 16 mass % in a conventional strip-cast alloy.

As described above, by using the alloy made by the method shown in FIG. 1, the powder can be sintered more efficiently, the rare natural resource such as Dy can function more effectively, and a sintered magnet with excellent coercivity can be provided at a reduced cost. Furthermore, none of the problems to be caused by an ingot alloy, i.e., production of α-Fe and difficulty in sintering, arises anymore and the manufacturing cost is never increased by the solution treatment. More specifically, the concentration of the rare-earth element can be within the range of 27 mass % to 35 mass % and the α-Fe phase to be included in the as-cast solidified alloy yet to be thermally treated can be reduced to 5 vol % or less. As a result, the solidified alloy no longer needs to be thermally treated unlike the conventional ingot alloy.

Furthermore, in a preferred embodiment of the present invention, even if the powder has a relatively large mean particle size, the respective powder particles become polycrystalline much less often than the alloy powder prepared by a normal rapid cooling process, and achieves high magnetic anisotropy, thus making the resultant sintered magnet magnetizable very easily. By setting the mean particle size relatively large, the powder can exhibit increased flowability. In addition, the overall surface area of the powder particles decreases with respect to a unit mass, and therefore, the degree of activity of the superfine powder to an oxidation reaction decreases. As a result, the amount of the rare-earth element to be wasted due to the oxidation decreases and the resultant magnet performance deteriorates much less easily.

### EXAMPLES

Setting the composition shown in the following Table 1 as a target, solidified alloys to be rare-earth-iron-boron based magnet alloys were made by the three methods, namely, the method of the present invention (i.e., centrifugal casting process), a strip casting process and an ingot process. The alloys obtained by these three methods will be referred to herein as Alloy A, Alloy B and Alloy C, respectively. In an alloy to which the present invention is applied, Dy and Tb behave in substantially the same way. Thus, an example including Dy as an additive will be described.

TABLE 1

| Nd | Pr | Dy | B | Co | Al | Cu | Fe |
|---|---|---|---|---|---|---|---|
| 15.0 | 5.0 | 10.0 | 1.0 | 0.9 | 0.3 | 0.1 | Bal |

where “Bal” means the balance. The numerals in Table 1 indicate the respective mass percentages of the elements on the upper row to the overall alloy.

In the centrifugal casting process of this example, the alloy was made by scattering a melt having the composition specified above (at about 1,300° C.) with a centrifugal force toward the inner surfaces of a rotating cylindrical cooling member and cooling and solidifying the scattered melt on the inner surfaces of the cooling member. On the other hand, the strip-cast alloy was obtained by rapidly cooling and solidifying a melt having the composition specified above (at about 1,400° C.) through the contact with the outer surface of a water-cooled chill roller (made of copper) rotating at a peripheral velocity of 1 m/s. The resultant rapidly solidified alloy were cast flakes with a thickness of 0.2 mm. And the ingot-cast alloy was obtained by pouring a melt having the composition specified above (at about 1,450° C.) into a water-cooled iron die and gradually cooling it there. The resultant ingot cast alloy had a thickness of about 25 mm.

In this example, Alloys A, B and C obtained by the methods described above were coarsely pulverized by a hydrogen decrepitation process and then finely pulverized with a jet mill.

The hydrogen decrepitation process was carried out in the following manner. First, the material alloy was loaded into a hydrogen process furnace airtight. The furnace was evacuated and then filled with an H₂ gas at 0.3 MPa, thereby performing a pressuring process (i.e., hydrogen absorption process) for an hour. Thereafter, a vacuum was created again in the hydrogen process furnace and a heat treatment was carried out at 400° C. for three hours in that state, thereby performing a dehydrogenation process of removing excessive hydrogen from the alloy.

In pulverizing the alloy with a jet mill, an N₂ gas at 0.6 MPa was used as a pulverizing gas, which had an oxygen concentration of 0.1 vol %.

It should be noted that when the decrepitated alloys were fed into the jet mill, the feeding rates of the alloys were adjusted, thereby making fine powders with two different particle size distributions out of each of Alloys A, B and C.

The various fine powders obtained in this manner were compressed and compacted under an aligning magnetic field to make compacts. The compaction process was carried out under the following set of conditions on each of the three alloys:
Aligning magnetic field strength: 1.0 MA/m;
Pressure on powder: 98 MPa; and
Direction of aligning magnetic field: perpendicular to the direction in which the pressure was applied.

The compacts obtained in this manner were sintered at various temperatures, thereby making sintered bodies. After having been subjected to an aging treatment (at 520° C. for an hour), each sintered body (or sintered magnet) had its composition analyzed. The results of the analysis are shown in the following Table 2 (where the “pulverized particle size” on the leftmost column is an FSSS mean particle size):

TABLE 2

| | | Nd | Pr | Dy | Fe | Co | Al | Cu | B | O |
|---|---|---|---|---|---|---|---|---|---|---|
| Alloy A (this | | 15.1 | 4.95 | 9.95 | 66.5 | 0.91 | 0.25 | 0.10 | 1.00 | 0.03 |
| invention) | | | | | | | | | | |
| 3.1 μm | Fine | 14.9 | 4.90 | 10.06 | 66.8 | 0.91 | 0.26 | 0.10 | 1.00 | 0.30 |
| | Sintered | 14.9 | 4.90 | 10.06 | 66.9 | 0.92 | 0.25 | 0.10 | 1.00 | 0.32 |
| 3.6 μm | Fine | 15.0 | 4.92 | 10.08 | 66.8 | 0.92 | 0.24 | 0.11 | 1.01 | 0.28 |
| | Sintered | 14.9 | 4.91 | 10.09 | 66.8 | 0.92 | 0.24 | 0.10 | 1.00 | 0.29 |
| Alloy B (SC) | | 15.2 | 4.98 | 9.98 | 66.3 | 0.89 | 0.24 | 0.09 | 0.99 | 0.03 |
| 2.8 μm | Fine | 14.6 | 4.86 | 9.92 | 67.0 | 0.90 | 0.25 | 0.10 | 1.00 | 0.31 |
| | Sintered | 14.7 | 4.88 | 9.91 | 66.9 | 0.90 | 0.24 | 0.09 | 1.00 | 0.32 |
| 3.4 μm | Fine | 14.7 | 4.89 | 9.94 | 66.8 | 0.89 | 0.24 | 0.09 | 0.99 | 0.29 |
| | Sintered | 14.7 | 4.89 | 9.94 | 66.9 | 0.90 | 0.24 | 0.09 | 1.00 | 0.30 |
| Alloy C | | 15.1 | 4.99 | 9.93 | 66.4 | 0.92 | 0.25 | 0.10 | 1.00 | 0.03 |
| (ingot) | | | | | | | | | | |
| 3.2 μm | Fine | 14.5 | 4.83 | 9.95 | 66.9 | 0.93 | 0.24 | 0.10 | 1.00 | 0.29 |
| | Sintered | 14.5 | 4.85 | 9.95 | 67.0 | 0.93 | 0.25 | 0.10 | 1.00 | 0.30 |
| 3.6 μm | Fine | 14.6 | 4.85 | 9.97 | 66.8 | 0.92 | 0.25 | 0.09 | 1.00 | 0.27 |
| | Sintered | 14.6 | 4.86 | 9.96 | 66.8 | 0.93 | 0.25 | 0.10 | 1.00 | 0.29 |

The numerals in Table 2 represent multiple compositions, each consisting of their associated elements (in mass percentages). More specifically, Table 2 shows the compositions of the material alloy, fine powder and sintered body for each of two powders with different particle sizes that were made from Alloy A, B or C. By checking out the compositions at these stages, the variation in composition before and after the pulverization process can be understood.

As can be seen from Table 2, Alloy A of the present invention has a higher Nd concentration and a higher Dy concentration in the fine powder than any other alloy B or C. This means that Nd and Dy included in the alloy are not lost easily during the hydrogen decrepitation process or the fine pulverization process with the jet mill.

The reason is believed to be as follows. In the conventional strip-cast alloy (i.e., Alloy B) and ingot cast alloy (i.e., Alloy C), a light rare-earth element such as Nd is present on the grain boundary at a higher concentration than that defined by the stoichiometry of R₂Fe₁₄B type crystals and in the main-phase crystal grains at the concentration defined by the stoichiometry of R₂Fe₁₄B type crystals. On the other hand, a heavy rare-earth element such as Dy is broadly distributed in the grain boundary and main phases in Alloy B, in particular. Also, the hydrogen decrepitation process makes the alloy easily splitting by swelling the grain boundary portions with a high rare-earth element concentration. Accordingly, the superfine powder (with particle sizes of 0.5 μm or less) produced by the hydrogen decrepitation and fine pulverization processes comes from the grain boundary and includes a lot of Nd and Dy. Thus, in this example, such a superfine powder is removed while the powder is being collected with a jet mill. As a result, Nd and Dy are lost easily.

In contrast, when Alloy A is used, the rare-earth-rich phases are dispersed in the main-phase crystal grains with relatively large particle sizes, and therefore, fewer grain boundary phases (i.e., R-rich phases) are present between the columnar crystals. Furthermore, the heavy rare-earth element is hardly present on the grain boundary but is concentrated in the main phase. In view of these considerations, Alloy A has a very small amount of superfine powder and the percentage of Nd and Dy to be lost with the superfine powder decreases significantly during the hydrogen decrepitation process and the fine pulverization process with the jet mill.

Next, the magnetic properties of sintered magnets, made from the powders of Alloys A, B and C, are shown in the following Table 3:

TABLE 3

| | Pulver- | Sinter- | | | | | |
|---|---|---|---|---|---|---|---|
| | ized | ing | | | | | |
| | Particle | Temp- | | | | | |
| | Size | erature | Density | Br | HcB | HcJ | (BH)ₘₐₓ |
| Alloy | (μm) | (° C.) | (Mg/m³) | (T) | (kA/m) | (kA/m) | (kJ/m³) |
| A1 | 3.1 | 1040 | 7.4 | 1.17 | 895 | 2300 | 261 |
| A2 | 3.1 | 1050 | 7.5 | 1.18 | 903 | 2370 | 266 |
| A3 | 3.1 | 1060 | 7.6 | 1.20 | 918 | 2340 | 275 |
| A4 | 3.6 | 1040 | 7.2 | 1.15 | 888 | 2110 | 255 |
| A5 | 3.6 | 1060 | 7.5 | 1.19 | 919 | 2290 | 274 |
| A6 | 3.6 | 1080 | 7.6 | 1.21 | 935 | 2320 | 283 |
| B1 | 2.8 | 1040 | 7.5 | 1.15 | 875 | 2240 | 253 |
| B2 | 2.8 | 1050 | 7.6 | 1.17 | 890 | 2230 | 262 |
| B3 | 3.4 | 1040 | 7.5 | 1.12 | 845 | 2180 | 237 |
| B4 | 3.4 | 1050 | 7.6 | 1.14 | 860 | 2180 | 245 |
| C1 | 3.2 | 1060 | 7.3 | 1.14 | 872 | 1970 | 249 |
| C2 | 3.2 | 1080 | 7.6 | 1.19 | 911 | 1980 | 271 |
| C3 | 3.6 | 1070 | 7.2 | 1.13 | 873 | 1820 | 247 |
| C4 | 3.6 | 1090 | 7.5 | 1.17 | 903 | 1840 | 264 |

In Table 3, A1 through A6 are sintered magnets made from the powders of Alloy A, which had different mean particle sizes or sintering temperatures, B1 through B4 are sintered magnets made from the powders of Alloy B, and C1 through C4 are sintered magnets made from the powders of Alloy C.

It can be seen from Table 3 that when a sintered magnet was made from Alloy A, a higher density and superior magnetic properties were achieved at a lower sintering temperature compared to a situation where a sintered magnet was made from Alloy C. This means that the powder of Alloy A can be sintered more easily than that of Alloy C.

Also, even if the powder of Alloy A had a greater mean particle size than that of Alloy B, a sintered magnet made of the powder of Alloy A exhibited a higher remanence Br than a sintered magnet made of the powder of Alloy B. The reason is as follows. Specifically, the main phase size of Alloy A is greater than that of Alloy B. Accordingly, even if the powder particle size of Alloy A is relatively large, those powder particles still have high magnetic anisotropy and the sintered magnet has an increased degree of magnetic orientation.

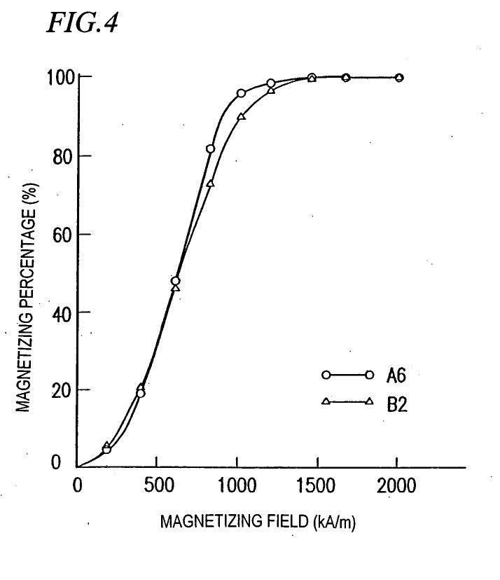

The magnetization characteristics of the sintered magnets A6 and B2 were evaluated. FIG. 4 is a graph showing the magnetization characteristics. The abscissa represents the strength of the magnetizing field applied to the sintered magnet while the ordinate represents the magnetizing percentage. As can be seen from FIG. 4, the sintered magnet A6 exhibited improved magnetization characteristic as compared with the sintered magnet B2. This is believed to be because Alloy A had a greater main phase size than Alloy B did and a uniform texture, and could be magnetized more easily.

Next, the atomic number ratio of the rare-earth elements included in each of the sintered magnets described above was calculated on the main phase alone and on the overall sintered magnet.

The results of calculations on the sintered magnets A3, B1 and C2 are shown in the following Tables 4, 5 and 6, respectively:

TABLE 4

| | Nd | Pr | Dy |
|---|---|---|---|
| Main phase alone | 50.3 | 17.2 | 32.5 |
| Overall sintered magnet | 51.6 | 17.4 | 31.0 |

TABLE 5

| | Nd | Pr | Dy |
|---|---|---|---|
| Main phase alone | 51.5 | 17.5 | 31.0 |
| Overall sintered magnet | 51.6 | 17.6 | 30.9 |

TABLE 6

| | Nd | Pr | Dy |
|---|---|---|---|
| Main phase alone | 51.1 | 17.1 | 31.8 |
| Overall sintered magnet | 51.4 | 17.5 | 31.1 |

The numerals included in these tables represent the atomic number ratio of Nd, Pr and Dy to the total rare-earth elements included in either the main phase or the overall sintered magnet (which will sometimes be referred to herein as a “ratio” simply).

As can be seen from these Tables 4, 5 and 6, the Dy ratio in the main phase is the highest in the sintered magnet made from Alloy A. As shown in Table 4, the Dy ratio in the overall sintered magnet is 31.0 but the Dy ratio in the main phase alone is 32.5, which is higher than 31.0 by as much as 4%. This means that the Dy concentration in the main phase is higher than that in the grain boundary phase (i.e., Dy is concentrated in the main phase). No such phenomenon reads from the results shown in Table 5 for Alloy B. Such a difference was created for the following reason. Specifically, when Alloy B is made by the strip casting process, the molten alloy is quenched at such a high rate that Dy is distributed uniformly in a broad range not only in the main phase but also in the grain boundary phase as well. In contrast, when Alloy A is made, the molten alloy is quenched at a relatively low rate. As a result, Dy diffuses into the main phase and can be settled there.

In a preferred embodiment of the present invention, the ratio of Dy and/or Tb in the main phase is at least 1.03 times as high as that of Dy and/or Tb in the overall alloy or sintered magnet. In order to increase the coercivity by using Dy and/or Tb more efficiently, the ratio of Dy and/or Tb in the main phase is more preferably at least 1.05 times as high as that of Dy and/or Tb in the overall alloy or sintered magnet.

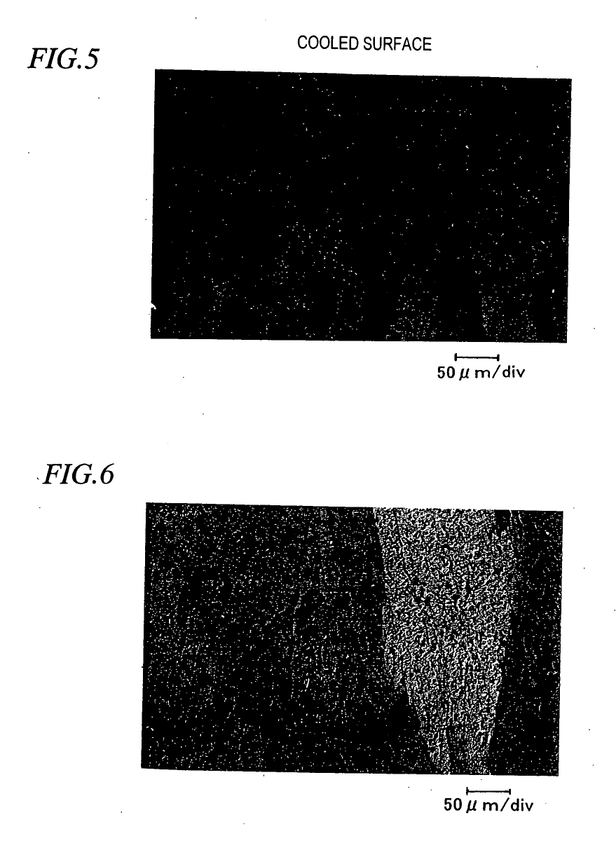

FIGS. 5 and 6 are polarizing micrographs of a rare-earth-iron-boron based magnet alloy according to the present invention showing a texture cross section near its surface contacting with the cooling member and a texture cross section of a center portion in the thickness direction, respectively. In FIGS. 5 and 6, the upside shows a cooled surface while the downside shows a heat-dissipating surface (i.e., free surface). As can be seen from FIGS. 5 and 6, a very small crystal texture (i.e., the first texture layer) is present up to about 100 μm away from the contact surface, while coarse columnar crystals are present in the inner region (i.e., the second texture layer) that is more than about 100 μm away from the contact surface. In the vicinity of the free surface on the other hand, although the very small texture is observed here and there, this region is mostly made up of coarse crystals. The alloy cast flake has a thickness of 5 mm to 8 mm, and is mostly composed of the second texture layer consisting essentially of coarse columnar crystals. It should be noted that the boundary between the first and second texture layers is definite somewhere but indefinite elsewhere.

Comparing the structures of a plurality of alloy samples with different rare-earth contents, the present inventors discovered that the higher the concentration of the rare-earth element included, the smaller the crystal grain size of the alloy.

When a compositional image of coarse crystal grains was observed, it was confirmed that rare-earth-rich phases were dispersed there. The greater the amount of rare-earth elements included in the solidified alloy, the greater the number of dispersed rare-earth-rich phases identified in the coarse crystal grains. No α-Fe phases were observed.

In pulverizing such an alloy into powder particles, the FSSS mean particle size thereof is preferably controlled so as to fall within the range of 3.0 μm to 5.0 μm. By pulverizing the alloy so as to obtain a greater mean particle size than the conventional one in this manner, the remanence Br of the sintered magnet can be increased and the concentration of oxygen included can be reduced.

### INDUSTRIAL APPLICABILITY

According to the present invention, Dy and Tb are concentrated in a main phase with a greater size than that of a rapidly solidified alloy, thus increasing the coercivity effectively. In addition, although the main phase included in the resultant solidified alloy has a relatively big size, no α-Fe is produced and the powder can be sintered sufficiently. As a result, the manufacturing cost of the sintered magnets can be reduced significantly.

1. A rare-earth-iron-boron based magnet alloy comprising, as a main phase, a plurality of R₂Fe₁₄B type crystals (where R is at least One element selected from the group consisting of the rare-earth elements and yttrium) in which rare-earth-rich phases are dispersed,
wherein the main phase includes Dy and/or Tb at a higher concentration than a grain boundary phase does.

2. The rare-earth-iron-boron based magnet alloy of claim 1, wherein the alloy includes 2.5 mass % to 15 mass % of Dy and/or Tb.

3. The rare-earth-iron-boron based magnet alloy of claim 1, wherein the ratio of Dy and/or Tb to the main phase is at least 1.03 times as high as the ratio of Dy and/or Pb to the overall alloy.

4. The rare-earth-iron-boron based magnet alloy of claim 1, wherein the alloy includes at most 5 vol % of α-Fe phase.

5. The rare-earth-iron-boron based magnet alloy of claim 1, wherein the alloy includes 27 mass % to 35 mass % of the rare-earth element.

6. A powder of the rare-earth-iron-boron based magnet alloy of claim 1.

7. A sintered magnet made from the rare-earth-iron-boron based magnet alloy powder of claim 6.

8. A method of making a rare-earth-iron-boron based magnet alloy, the method comprising the steps of: preparing a melt of a rare-earth-iron-boron based alloy; and making a solidified alloy by quenching the melt,
wherein the step of making the solidified alloy includes the step of forming a solidified alloy layer, including, as a main phase, a plurality of R₂Fe₁₄B-type crystals (where R is at least one element selected from the group consisting of the rare-earth elements and yttrium) in which rare-earth-rich phases are dispersed, by quenching the melt through contact with a cooling member, the main phase including Dy end/or Tb at a higher concentration than a grain boundary phase does.

9. The method of claim 8, wherein the alloy includes 2.5 mass % to 15 mass % of Dy and/or Tb.

10. The method of claim 8, wherein the ratio of Dy and/or Tb to the main phase is at least 1.03 times as high as the ratio of Dy and/or Tb to the overall alloy.

11. The method of claim 8, wherein the step of forming the solidified alloy layer includes forming a first texture layer in contact with the cooling member and then further feeding the melt onto the first texture layer to grow the R₂Fe₁₄B-type crystals on the first texture layer, thereby forming a second texture layer thereon.

12. The method of claim 11, wherein in forming the first texture layer, the melt is quenched at a rate of 10° C./s to 1,000° C./s and at a supercooling temperature of 100° C. to 300° C., and
wherein in forming the second texture layer, the melt is quenched at a rate of 1° C./s to 500° C./s.

13. The method of claim 8, wherein the R₂Fe₁₄B-type crystals have an average minor-axis size of at least 20 μm and an average major-axis size of at least 100 μm.

14. The method of claim 8 wherein the rare-earth-rich phases are dispersed at an average interval of 10 μm or less in the R₂Fe₁₄B-type crystals.

15. The method of claim 8, wherein the solidified alloy includes at most 5 vol % of α-Fe phase.

16. The method of claim 8, wherein the rare-earth element included in the solidified alloy has a concentration of 27 mass % to 35 mass %.

17. The method of claim 8, comprising the step of forming the solidified alloy layer by a centrifugal casting process.

18. A method of making a magnet powder for a sintered magnet, the method comprising the steps of:
preparing the rare-earth-iron-boron based magnet alloy by the method of claim 8; and
pulverizing the alloy.

19. A method for producing a sintered magnet, the method comprising the steps of:
preparing the rare-earth-iron-boron based magnet alloy powder of claim 6;
compressing the powder under an aligning magnetic field to make a compact; and
sintering the compact.
